(19) United States
(12) Patent Application Publication
(10) Pub. No.: US 2024/0296351 A1
(43) Pub. Date: Sep. 5, 2024

(54) REASONING WITH CONDITIONAL INDEPENDENCE GRAPHS

(71) Applicant: Microsoft Technology Licensing, LLC, Redmond, WA (US)

(72) Inventors: Urszula Stefania CHAJEWSKA, Camano Island, WA (US); Harsh SHRIVASTAVA, Redmond, WA (US)

(21) Appl. No.: 18/327,763

(22) Filed: Jun. 1, 2023

Related U.S. Application Data
(60) Provisional application No. 63/449,251, filed on Mar. 1, 2023.

(51) Int. Cl. G06N 5/022

(52) U.S. Cl. CPC G06N 5/022

(57) ABSTRACT

The present disclosure relates to propagating knowledge between nodes of a feature graph in inferring or otherwise predicting attribute values for various features represented within the feature graph. This enables analysis of the feature graph beyond direct dependencies and for domain spaces that are increasingly complex. The present disclosure includes generating a transition matrix based on correlations within the feature graph to determine distribution of weights to apply to an attribute matrix including a combination of known and unknown attribute values. Features described herein provide a computationally inexpensive and flexible approach to evaluating graphs of complex domains while considering combinations of features that are not necessarily directly correlated to other features.

### CROSS-REFERENCE TO RELATED APPLICATIONS

This application is related to and claims priority to U.S. Provisional Patent Application No. 63/449,251, filed Mar. 1, 2023, the entirety of which is hereby incorporated by reference.

### BACKGROUND

Recent years have seen a significant increase in the use of computing devices (e.g., mobile devices, personal computers, server devices) to create, store, analyze, and present data from various sources. Indeed, tools and applications for collecting, analyzing, and presenting data are becoming more and more common. These tools provide a variety of features for displaying data about various entities. In many cases, these tools attempt to generate and provide a display of a graph showing features of data and, more specifically, relationships between various features within a collection of instances of data (e.g., samples of data).

As entities become more complex, however, conventional methods for collecting, analyzing, and presenting data have a number of limitations and drawbacks. For example, current tools for exploring domains are often limited to machine learning tools that are capable of predicting a limited set of outputs based on inputs, but are limited in predictions for variables other than those in the output set. In addition, many tools for exploring graphs require robust and computationally expensive resources to effectively analyze complex datasets.

These and other limitations exist in connection with gaining insights from feature relationships within feature graphs (e.g., conditional independence graphs).

### BRIEF DESCRIPTION OF THE DRAWINGS

FIG. 1 illustrates an example environment including a computing device having a knowledge propagation system implemented thereon.

FIG. 2 illustrates an example workflow showing an implementation of a knowledge propagation system in accordance with one or more embodiments.

FIG. 3 illustrates a set of algorithms that may be used in connection with predicting or otherwise inferring attributes of samples from a collection of samples in accordance with one or more embodiments.

FIG. 4 illustrates an example implementation of the knowledge propagation system in connection with an example in which a transition matrix is derived by exponentiating a correlation matrix in accordance with one or more embodiments.

FIG. 5 illustrates an example series of acts for predicting attributes of samples from a dataset in accordance with one or more embodiments.

FIG. 6 illustrates certain components that may be included within a computer system.

### DETAILED DESCRIPTION

Probabilistic graphical models (PGMs) are a useful tool for domain exploration and discovery of domain structure. PGMs rely on probabilistic marginal independence and conditional independence assumptions between features to make representation, learning, and inference feasible in a variety of domains with a large number of features. Utilizing PGMs provides a number of benefits and overcomes various problems associated with conventional approaches to examining or otherwise analyzing large datasets.

For example, in addition to computational benefits, these independence properties give insight into relations between features in a given domain. Conditional independence (CI) graphs are a type of PGM that model direct dependencies between input features represented as nodes in an undirected graph where each edge represents a partial correlation between connected node features (e.g., dependent features). As noted above, these CI graphs can be used to gain insights about feature relations. Moreover, these CI graphs may provide insight about a plurality of different domains, from gene regulatory networks, increasing methane yield in anaerobic digestion, understanding brain connectivity in the context of differences among neurodivergent and neurotypical patients (e.g., humans and mice), and analyzing infant mortality data. In some instances, these CI graphs may be used to study evolving relationships of features over periods of time.

The present disclosure relates to systems, methods and computer readable media for using a feature graph (e.g., a conditional independence graph) to infer additional information about features (nodes) in a way that is applicable across a variety of information domains. In particular, one or more embodiments described herein use a feature graph created based on a collection of samples to predict or infer attributes of one or more features within the domain based on correlations that exist between the features of the samples. As will be discussed in further detail below, this involves generating a transition probability matrix (or matrices) based on correlations between features from the recovered graph. This transition probability matrix may be applied to a table or matrix of known and unknown attributes to determine a set of predicted attributes for each of a plurality of features represented within the graph.

More specifically, in the following disclosure, an algorithm for CI graphs is provided that may be used in a wide variety of domain spaces. More specifically, one or more embodiments described herein involve functions and models for propagating knowledge of attributes between nodes of a feature graph. As will be discussed below, this propagation of knowledge enables an individual or other entity to accurately determine predictions of unknown attributes based on feature relationships as well as known attributes for other features in a way the provides valuable insight based on all nodes of a graph while doing so in a computationally efficient manner.

The present disclosure provides a number of practical applications that provide benefits and/or solve problems associated with inferring attributes or other unknown data based on direct correlations that are determined within the graph. By way of example and not limitation, some of these benefits will be discussed below.

For example, embodiments of the knowledge propagation system described herein provide insights that are otherwise unavailable in other methods. For example, the knowledge propagation system facilitates prediction of attribute values based on correlations between features that may or may not necessarily be related to attributes of interest. In addition, where conventional models for analyzing graphs typically limit inferences based on those features that are directly dependent within a recovered graph, features of the knowledge propagation system described herein enable knowledge to be propagated between nodes that are indirectly dependent. In this manner, each node of a graph may potentially influence inferences and predictions of attribute values even where those nodes are not directly dependent to a node of interest. This facilitates more accurate predictions, particularly in graphs that represent complex entities.

The knowledge propagation system additionally provides the capabilities mentioned above using a computationally inexpensive approach to evaluating graphs. For example, by iterating updates of an attribute matrix in accordance with one or more embodiments described herein, the knowledge propagation system may determine attribute values for a given feature in a manner that only involves evaluation of direct dependencies for a given iteration, but is nonetheless influenced by features and attribute values of other non-direct dependencies when performed over multiple iterations. Indeed, as more iterations are performed, non-direct dependencies provide additional insight, which is conventionally a complex and computationally expensive problem. As discussed above, the knowledge propagation system facilitates a simpler consideration of direct dependencies for each iteration; however, by propagating knowledge between iterations, the knowledge propagation system allows non-direct dependencies to influence the output predictions.

In addition to allowing knowledge to propagate throughout nodes of the graph, the knowledge propagation system may consider a regularization term to be used in enabling the knowledge propagation system to converge to an output prediction of attribute values more or less slowly. This regularization term can reduce inaccuracies in the prediction by reducing the amount of fluctuation between iterations. The regularization term may further be optimized to allow the functions to converge after some predetermined number of iterations (e.g., rather than performing a large number of iterations to simply ensure that the values converge with a high degree of confidence). In some embodiments, the regularization term may be a distance metric between the uniform distribution and a distribution over attribute values for a given node computed in the latest iteration. In other embodiments, it can be a distance metric between the distributions over attribute values for a given node computed in the previous iteration and the current iteration. An example of such distance metric can be Kullback-Leibler divergence or Wasserstein distance. It can also be another appropriate distance metric between two distributions.

The features and functionality of the knowledge propagation system are also scalable to a wide variety of computing environments. For example, where computing resources may be limited or expensive for a particular computing environment, the knowledge propagation system may employ the iterative approach as discussed herein. Alternatively, where computing resources are readily available, the knowledge propagation system may employ a more computationally expensive analytical or graphical neural network approach in determining an output prediction of attribute values.

The knowledge propagation system additionally provides flexibility with respect to a variety of domain spaces. Indeed, features described herein in connection with generating a partial correlation matrix and a transition matrix are applicable to virtually any number of conditional independence graphs. As noted above, this flexibility extends to large and complex datasets, as well as a wide variety of domains, such as a corpus of documents, organisms in an anaerobic digestion process, tracking relationships of features over periods of time, and so on.

As used herein, “input data” refers to a collection of input samples and associated features of the input samples. For example, input data may include a table of values including columns and rows in which the rows indicate a plurality of samples or subjects or other entities while each of the columns indicate features of the corresponding samples. As used herein, “features” or “sample features” refer interchangeably to characteristics or values that are descriptive or otherwise associated with a corresponding instance of an input sample. Examples of features and samples that may be included within a collection of input data are provided below. The features herein refer specifically to features on which a graph is generated (e.g., features for which correlations are determined and used to generate the graph).

As used herein, a “graph” or “feature graph” may refer to a data object in which features associated with a collection of samples are represented in a way that can be visualized to show direct dependencies (or direct connections) between various features. In one or more embodiments described herein, a feature graph refers to a visualization of features and associated dependencies by way of nodes that represent respective features and dependencies between the features that have been determined to satisfy one or more sparsity constraints. More specifically, a sparse graph may include a set of features and corresponding dependencies that represent some subset of all possible dependencies between features of the input data where the subset of dependencies indicates direct dependence (represented by connection) between the features. By enforcing sparsity, the graph recovery algorithm learns dependencies that are least likely to be spurious (e.g., false), that is, due to noise in the data. In some embodiments, the graph may be a conditional independence graph where feature Xᵢ is not directly connected to feature Xⱼ if and only if features Xᵢ and Xⱼ are conditionally independent given all other features in the distribution learned based on the input dataset.

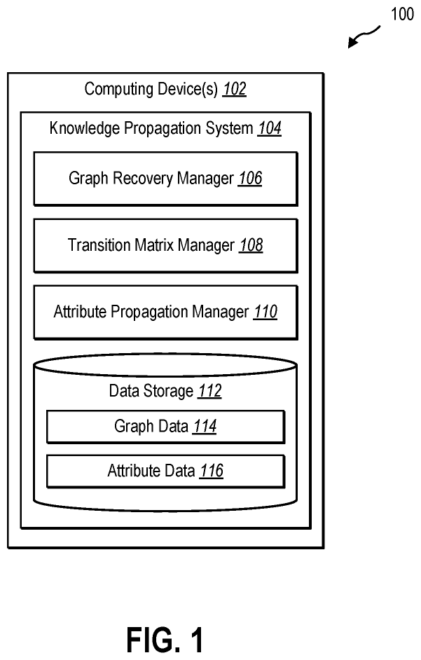

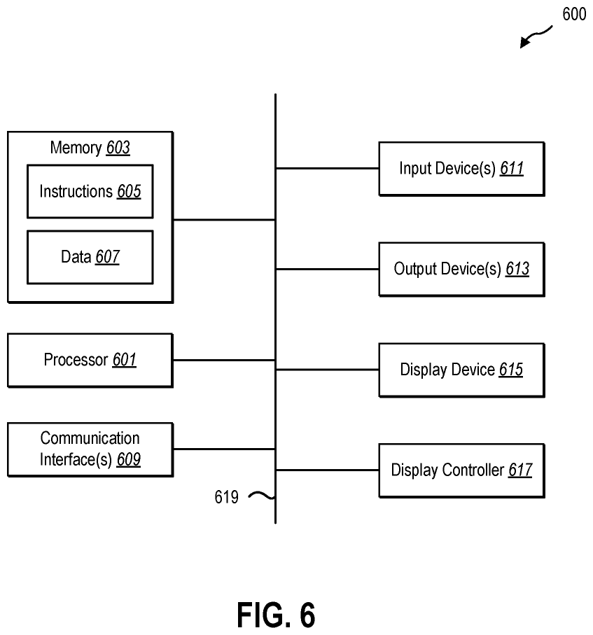

Additional detail will now be provided regarding a knowledge propagation system in accordance with one or more embodiments. For example, FIG. 1 illustrates an example environment 100 including one or more computing devices 102 having a knowledge propagation system 104 implemented thereon. The computing device 102 may refer to a variety of different computing devices 102 on which a knowledge propagation system 104 may be implemented. For example, the computing device 102 may include a mobile device such as a mobile telephone, a smartphone, a personal digital assistant (PDA), a tablet, or a laptop. Additionally, or alternatively, the computing device 102 may include a non-mobile device such as a desktop computer, server device, or other non-portable device. The computing device 102 (and other devices described herein) may include features and functionality described below in connection with FIG. 6.

As shown in FIG. 1, the computing device 102 includes a knowledge propagation system 104 implemented thereon. The knowledge propagation system 104 may include a number of components. For example, as shown in FIG. 1, the knowledge propagation system 104 includes a graph recovery manager 106, a transition matrix manager 108, and an attribute propagation manager 110. The knowledge propagation system 104 may additionally include a data storage 112 having graph data 114 and attribute data 116 stored thereon.

While FIG. 1 shows an example in which the components of the knowledge propagation system 104 are contained within a single computing device 102, one or more implementations may include components (or sub-components) implemented across multiple devices. For example, the graph recovery manager 106 may be implemented on a separate device or system of devices for obtaining a feature graph and associated feature and attribute data while the transition matrix manager 108 and/or attribute propagation manager 110 are implemented on a different device or system of devices.

Additional information will now be discussed in further detail in connection with various components of the knowledge propagation system 104. For example, the graph recovery manager 106 may facilitate acts related to recovering a feature graph based on a collection of input data. The feature graph may be recovered or obtained in a number of ways. In one or more embodiments, the graph recovery manager 106 simply receives a feature graph previously generated together with an associated partial correlation matrix.

In one or more embodiments, the graph recovery manager 106 generates or otherwise obtains a feature graph that is created or recovered based on a variety of recovery methods. For example, the graph recovery manager 106 may obtain or generate a graph based on a variety of graph recovery approaches, such as a partial correlation approach, a graphical lasso approach (e.g., optimization, deep learning, tensor based), or a regression-based approach.

In addition to generally recovering the graph, the graph recovery manager 106 may perform one or more acts related to manipulating input values. For example, the graph recovery manager 106 may perform normalization in which values of the input data are normalized to a predetermined range of values (e.g., 0 to 1, −1 to +1) based on any of a variety of normalization procedures (e.g., min-max, mean, log-ratios, etc.). Where the features are represented using mixed datatypes, the graph recovery manager 106 may perform any of a number of correlations or associations to calculate values that fit the normalized range of values.

Once data is normalized and a graph is recovered, the feature graph and the associated partial correlation matrix may be provided to the transition matrix manager 108 for further processing. As will be discussed in further detail below, the transition matrix manager 108 may perform a number of acts related to converting a partial correlation matrix including correlation values indicative of direct correlations between features of the feature graph into a probability transition matrix. In one or more embodiments, a partial correlation matrix will include positive and negative correlation values represented as numbers within the normalized range of values. The correlation values are non-zero values for those correlations that are associated with direct dependencies. The correlation values are zero for those feature pairs that are not linked by direct dependencies. In one or more embodiments, this results in a partial correlation matrix including a plurality of zero values for features that are not directly dependent, positive values for features that are positively correlated, and negative values for features that are negatively correlated.

The transition matrix manager may generate a transition probability matrix (or simply “transition matrix”) based on the values associated with the various features. In one or more embodiments, the transition matrix manager generates the transition matrix by exponentiating each cell of the partial correlation matrix and row-normalizing, such that a distribution of values is created for each row of the correlation matrix in which a sum of the values is equal to 1, so that the row represents a valid probability distribution. In one or more embodiments, the transition matrix manager identifies a scaling intensity parameter (e.g., a configurable, programmable, or otherwise customizable scaling intensity parameter) and determines a transition value for each cell of the transition matrix based on an initial value of the corresponding cell within the partial correlation matrix, the scaling intensity parameter, and other cells within a row of the partial correlation matrix.

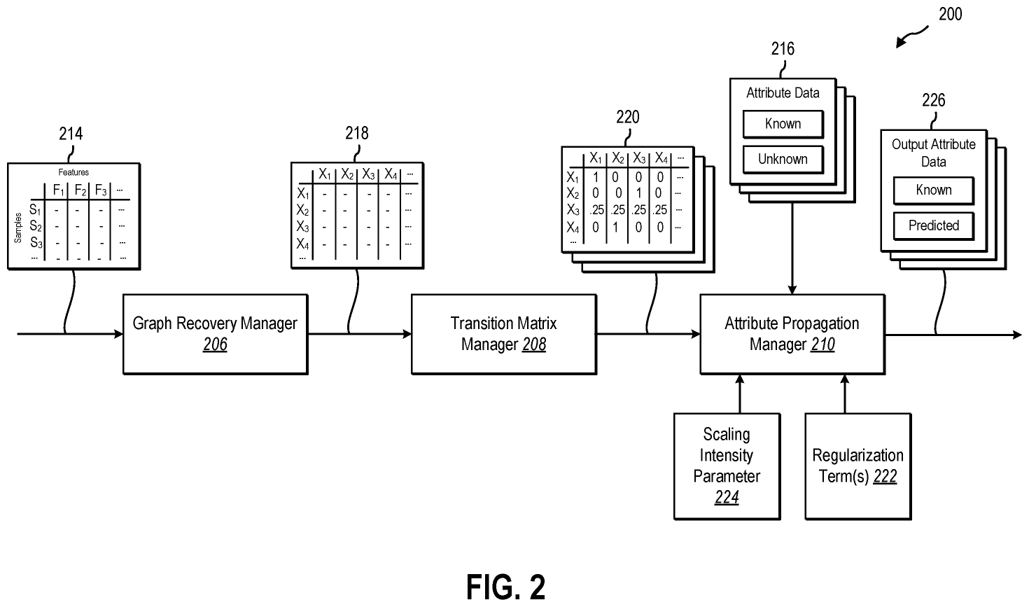

In one example, each cell is determined based on an exponent of a product of the scaling intensity parameter and a cell value of the partial correlation matrix over a sum of similar exponents for each cell of the same row of cells from the partial correlation matrix. This may be expressed as follows:

$${P}_{i , j}^{e} = \frac{{e}^{{αP}_{i , j}}}{{\sum }_{j}^{D} {e}^{{αP}_{i , j}}}$$

In which P_{i,j} is a partial correlation cell value (located at i, j) and α is the scaling intensity parameter. Additional information in connection with further features of the transition matrix manager will be discussed below in connection with FIGS. 2-4B.

In some embodiments, two matrices will be generated, P⁺ for the transition matrix containing just the positive correlations and similarly P⁻ for negative correlations:

$${P}_{i , j}^{+} = \{ \begin{matrix}{P}_{i , j} & {P}_{i , j} > 0 \\ 0 & otherwise .\end{matrix}$$

$${P}_{i , j}^{-} = \{ \begin{matrix}- 1 * {P}_{i , j} & {P}_{i , j} < 0 \\ 0 & otherwise .\end{matrix}$$

P⁺ and P⁻ are then normalized row-wise:

$${P}_{i , j}^{+} = \frac{{P}_{i , j}^{+}}{{\sum }_{j}^{D} {P}_{i , j}^{+}} , \qquad {P}_{i , j}^{-} = \frac{{P}_{i , j}^{-}}{{\sum }_{j}^{D} {P}_{i , j}^{-}}$$

As further shown in FIG. 1, the knowledge propagation system 104 includes an attribute propagation manager 110. In one or more embodiments, the attribute propagation manager 110 obtains attribute information indicating one or more attribute values for a subset of the features.

Examples of attributes may include a characterization of a particular feature, and may differ significantly between different domains. To illustrate, where the domain of interest is a collection of papers where each feature represents a paper and each instance indicates a number of times a given word appears in the paper, with the graph determining correlations based on counts of words, different attributes may refer to topics, styles or other characteristics of the respective papers. In the example where the domain of interest is a collection of organisms represented as features that are correlated based on counts or abundancy metrics of the respective organisms at different times during an anaerobic digestion process, different attributes may include classification of the organisms as acetogens, methanogens, or other classification of the organisms.

As noted above, while features of a given graph may refer to values on which the graph was trained and on which the correlations are determined, the attributes may refer to other characteristics of the features. In one or more embodiments, the attributes may include a mix of known and unknown attributes. For example, many of the features may have known characteristics or labels that have been tagged or otherwise associated with the corresponding features (e.g., ground truth data). Alternatively, some of the features may have unknown characteristics or absence of labels associated therewith.

The attribute propagation manager 110 may consider the known and unknown attributes in combination with values of the transition matrix to determine attribute values for the collection of features. In one or more embodiments, the attribute propagation manager 110 identifies attribute values for each of a plurality of features and stores the attribute values within an attribute matrix (e.g., a table of attribute values).

As noted above, the attribute values may include a mix of known and unknown values. For example, the attribute values may be represented as an attribute matrix, with each row corresponding to a single feature and each column to one possible attribute value (or vice versa). As such, the attribute matrix may include a first subset of attribute values corresponding to known values of the features. In addition, the attribute matrix may include a second subset of attribute values corresponding to unknown values of the features. In this example, the known values will have a value of 1 for the appropriate attribute column and zero for all other columns. In contrast, the unknown values may be initiated to a uniform distribution of values between the possible attribute values.

As an example, where a feature refers to a type of organism in an anaerobic digestion process, an attribute may refer to a classification or function of the organism with the digestion process (e.g., acidogenic, methanogenic, hydrolysis). Where a first organism that is a known methanogen may be associated with a zero value for each of the attributes of acidogenic and hydrolysis and a one value for the methanogenic attribute (e.g., indicating a known classification as a methanogenic organism), a second organism may be unknown. In this example, the second organism may be initiated or determined to have an initial uniform distribution of attribute values at ⅓ acidogenic, ⅓ methanogenic, and ⅓ hydrolysis.

Upon determining the attribute values for each feature of interest and including the attribute values within the attribute matrix, the attribute propagation manager may apply the transition matrix to the attribute matrix to determine an updated set of attribute values in which the values are shifted based on correlations between the features of unknown attribute values and the features for which attribute values are known. Considered broadly, this would cause attributes for features of unknown attributes that are strongly correlated with features of known attributes to shift in a similar direction as the known attributes. Conversely, where attributes for features of unknown attributes are negatively correlated with features of known attributes, this would cause the values of the unknown attributes to shift in a different direction, and cause the resulting distribution of attributes to weigh against the negative correlated features.

As a result of applying the transition matrix or matrices to the attribute matrix, the values of the attributes will shift in a way that attributes of unknown values will begin to converge towards known attribute values of features that are positively correlated within the recovered graph. This is based on positively correlated features having higher weighted values than negatively correlated features (in the embodiment with the exponential matrix) or different directionality (in the embodiment with positive and negative transition matrices), making the path to the positively correlated values more favorable paths to be traversed, and therefore known attribute values can be correlated with unknown attribute values having similar features. As an example, where a first feature (e.g., a first organism) is strongly classified as a methanogen, and where the first feature is positively correlated to a second feature having an unknown attribute value (and thus corresponding to a higher value within the transition matrix than a value between two unrelated or negatively correlated features), the attribute value of the second feature will shift in favor of a methanogen classification.

It will be understood that these examples are provided by way of example only, and are not intended to limit any specific implementation to these specific examples. Moreover, while one or more examples described herein relate to single correlations having a significant impact on attribute values over any other features from a set of sample features, it will be understood that many graphs may have a significant number of correlated features such that attributes of a single feature are influenced by multiple features, including features that are correlated, but have different attribute values.

As noted above, this application of the transition matrix to the attribute matrix may be performed in connection with a variety of techniques. For example, as will be discussed in further detail below, the attribute matrix may be updated based on the transition matrix using an iterative process in which the attribute values change over multiple iterations and converge to a set of attribute values that are predicted or otherwise inferred for a corresponding sample feature. For example, the iterative process may be performed with the following sample equation, or any other similar or suitable equation for iterating and updating the attribute matrix:

$${n}_{U}^{i} ← {P}^{+} \cdot {n}^{t - 1} + {D}_{KL} ( {n}_{U}^{0} , {P}^{+} \cdot {n}^{t - 1} ) + {D}_{KL} ( {n}_{U}^{0} , {P}^{-} \cdot {n}^{t - 1} )$$

(where P⁺ and P⁻ are positive and negative transition matrices as described above, n^{k} is the attribute matrix at k^{th} step in the iteration and D_{KL} stands for Kullback-Leibler divergence between its two arguments which represent two distributions.

In one or more embodiments, this iterative approach involves a regularization factor in which an amount of change is dampened or amplified in some way. For example, the regularization factor may cap a distance between distributions of values (e.g., attribute values) from one iteration to the next. In one or more embodiments, the regularization factor reduces or limits a distance or percentage that any single or set of attributes may shift between iterations. The regularization factor may change over time, or may be set at a different value as may be determined for a particular implementation.

In one or more embodiments, the known attributes are fixed between iterations, and only distributions for the unknown attributes are allowed to shift. Alternatively, in one or more embodiments, both the known and unknown attributes are allowed to shift in generating a set of predicted attribute values for a set of features. It will be understood that in applying the algorithms described herein, both the known and unknown attribute values may have an effect on the shifting attribute values of other features. For example, where two features are associated with unknown attribute values, the unknown values would likely not have an effect on a first iteration where an initial distribution of attribute values are uniform across the different attribute classifications. However, as the unknown attributes shift away from the uniform distribution, this non-uniformity would have an effect on additional iterations in which the transition matrix is applied to the attribute matrix.

In some embodiments, attributes may be partially known, corresponding to partially known attribute values. Partially known attribute values may be expressed in the form of a probability distribution over all possible attribute values. For example, it may be known that a given organism is most likely (90%) an acidogen, but there is a small chance (10%) that it is involved in hydrolysis. In this case, the appropriate row in the attribute matrix may be initialized to this distribution. In some embodiments, this distribution may be allowed to change during attribute propagation, and in others it may be kept fixed.

In some embodiments, the update for each feature in each iteration of the iterative solution will be performed based on two transition matrices: P⁺ and P⁻ reflecting positive and negative correlations. Both matrices will be applied to the attribute matrix and the final update will be a combination of one or both results of such application and one or both regularization terms based on distribution distance.

In some embodiments, the update for each feature in each iteration of the iterative solution may be performed based on the positive transition matrix P⁺ only, reflecting positive correlations.

In contrast to the iterative process, the attribute propagation manager 110 may perform an analytical process. While the iterative process provides a computationally efficient method (e.g., relative to other techniques described herein), the analytical process provides an approach in which applications of the transition matrix are applied to an attribute matrix with a single set of calculations that simulates the iterative approach to an infinite number of iterations. For example, the attribute propagation manager 110 takes a limit of the iterative approach to infinity to determine a distribution of attributes when completely converged.

In some embodiments, an analytical approach may be implemented to determine a distribution of attributes over the features with unknown attributes. By sorting the transition matrix by features based on known and unknown attributes, the transition matrix may be split into a plurality of sub-matrices based on this sorting. For example, the transition matrix may be separated into 4 submatrices. A first (e.g., upper-left) submatrix may include features of unknown attributes in both columns and rows. A second (e.g., upper-right) submatrix may include features of known attributes in columns and features of unknown attributes in rows. A third (lower-left) submatrix may include features of unknown attributes in columns and feature of known attribute in rows. A fourth (lower-right) submatrix may include features of known attributes in both rows and columns. The plurality of submatrices may be functionally combined, for example, with a known attribute matrix comprised of features having known attribute values to generate the predicted attribute values.

In accordance with at least one embodiment of the present disclosure, an analytical approach may be represented by and/or may implement one or more of the following equations. For example, if the known attribute values (n_{K}) and unknown attribute values (n_{U}) are represented as

$$n = [ \begin{matrix}{n}_{K} \\ {n}_{U}\end{matrix} ] ,$$

and the transition probability matrix is represented as

$${P}^{e} = [ \begin{matrix}{P}_{UU}^{e} & {P}_{UK}^{e} \\ {P}_{KU}^{e} & {P}_{KK}^{e}\end{matrix} ]$$

then the analytical approach may be represented as

$${n}_{U} = {lim}_{t \to ∞} {( {P}_{U U}^{e} )}^{t} \cdot {n}_{U}^{0} + ( {\sum }_{i = 1}^{t} {( {P}_{UU}^{e} )}^{( i - 1 )} ) {P}_{UK}^{e} \cdot {n}_{K}$$

As further shown in FIG. 1, the knowledge propagation system 104 includes a data storage 112 having different types of data thereon. For example, the data storage may include graph data 114, which may include any information about the recovered feature graph. The graph data 114 may include the features and associated correlations. The graph data 114 may include values associated with the correlations. In one or more embodiments, the graph data 114 includes only values for direct correlations (e.g., correlations that satisfy a sparsity constraint that limits the number of correlated feature pairs to those that are unlikely to be caused by noise in the data). In one or more embodiments, the graph data 114 includes all values between each feature pair represented within a collection of samples.

As further shown, the data storage may include attribute data 116. The attribute data 116 may include a combination of known, partially known and unknown attributes. The attribute data 116 may include any number of attributes referring to characteristics of the various features that the graph was not necessarily trained or generated on. For instance, where a collection of samples refers to a collection of words having features indicating whether each word was found within each paper, the attributes may include indications of specific topics, themes, lengths, authors, or any other attribute unrelated to generation of the graph and the correlations determined therein.

FIG. 2 illustrates an example workflow 200 of the knowledge propagation system in accordance with one or more embodiments. As shown in FIG. 2, the workflow 200 includes interactions between a graph recovery manager 206, a transition matrix manager 208, and an attribute propagation manager 210. Each of the features of the respective components discussed above in connection with FIG. 1 may similarly apply to the components shown in FIG. 2.

For example, as shown in FIG. 2, the graph recovery manager 206 may receive a recovered graph 214. In accordance with examples discussed above, the recovered graph 214 may include normalized values indicating correlations between features of samples on which the recovered graph 214 was trained. In addition, as discussed above, the recovered graph 214 may be recovered using one of a variety of different recovery techniques. As shown in FIG. 2, the graph recovery manager 206 passes the recovered graph 214 and the associated partial correlation matrix 218 (or simply “correlation matrix 218”) to the transition matrix manager 208.

Based on the correlation matrix 218, the transition matrix manager 208 may generate a transition matrix 220 by generating distributions of values for the features. As discussed above, the distributions of values may be based on the values of direct dependencies within the graph as well as the zero values that are associated with non-direct dependencies within the graph (e.g., nodes within the graph that are not directly dependent). In one or more embodiments, the transition matrix manager 208 considers a scaling intensity parameter 224 that affects the scaling intensity of the distribution. As noted above, the scaling intensity parameter 224 can be adjusted to achieve a desired scale or to affect the rate at which the convergence is attained when determining precited attribute values.

Upon generating the transition matrix or matrices 220, the transition matrix manager 208 may pass the transition matrix or matrices 220 as an input to the attribute propagation manager 210. The attribute propagation manager 210 may receive attribute data 216 and the transition matrix 220. The attribute data 216 may include a set of attributes including known and unknown attributes or partially known attributes in the form of distributions over attribute values. In one or more embodiments, the attribute propagation manager 210 additionally receives a regularization term(s) 222 that affects a rate at which the attribute values converge (e.g., using the iterative method).

As shown in FIG. 2, the attribute propagation manager 210 may generate a plurality of output attribute data 226 (or values) for a corresponding plurality of sample features. The output attribute data 226 may be in the form of an output attribute graph. For example, the output attribute graph may be the original recovered graph with predicted and known attributes associated with or marked next to their corresponding feature nodes. The output attribute data 226 may be in the form of an output attribute matrix. The output attribute data 226 may include a combination of known and predicted attribute values based on an application of the transition matrix 220 to the attribute data 216 having the combination of known and unknown attribute values.

As noted above, generation of the output attribute data 226 may be performed in a variety of ways. In one or more embodiments, output attribute values 226 are obtained using an iterative approach. In one or more embodiments, the output attribute values 226 are obtained using an analytical approach.

The output attribute data may be represented as either point values or as a full probability distribution. For output attribute data represented as point values, the attribute value with the highest probability in each row of the output instance of the attribute matrix may be assigned to the feature represented in that row, and may be assigned a value of 1. For attribute data represented as a full probability distribution, the attribute matrix may be populated with one or more values indicating the probability of value assignment for all possible attribute values.

In some embodiments, point value assignment is made only in cases where the value with highest probability exceeds a prespecified threshold or the distribution has low entropy.

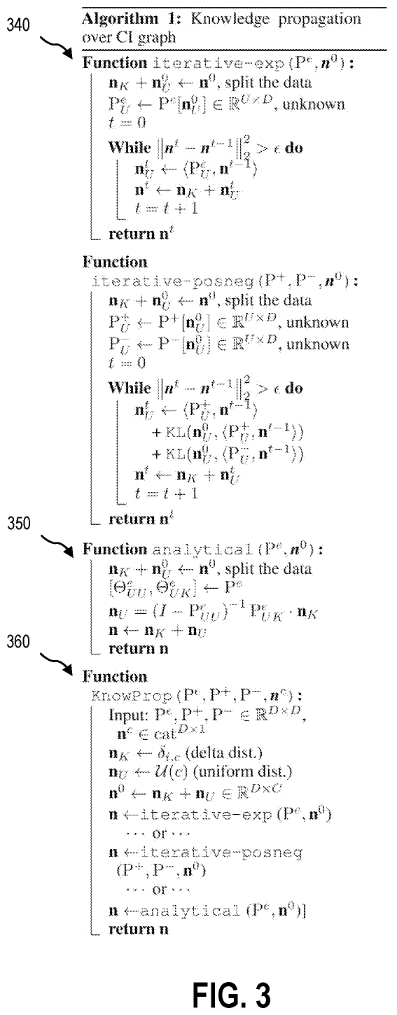

Examples of these techniques are shown in FIG. 3. For example, FIG. 3 shows an example iterative function 340 in accordance with one or more embodiments described herein. FIG. 3 additionally shows an example analytical function 350 in accordance with one or more embodiments described herein. FIG. 3 further shows an example knowledge propagation function 360 in accordance with one or more embodiments described herein. For example, the iterative function, the analytical function, and/or the knowledge propagation function may facilitate determining the set of predicted values for the unknown attributes.

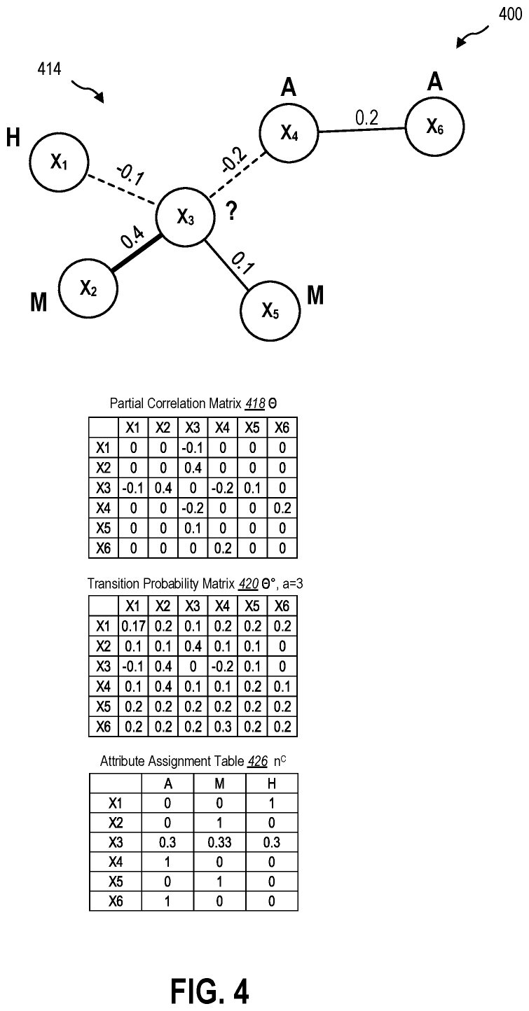

Referring now to FIG. 4, this shows an example implementation 400 of features and functionalities of the knowledge propagation system discussed above (e.g., knowledge propagation system 104 of FIG. 1). In particular, FIG. 4 illustrates an application of an analytical function 450 and a knowledge propagation function 460 (such as those shown in FIG. 3) in connection with example instances of a partial correlation matrix 418, a transition matrix 420 resulting from exponential transformation with α=3, and an example initial attribute matrix 426. Moreover, FIG. 4 shows an example graph 414 indicating correlations between a set of features (x₁-x₆).

For the sake of the illustrated example and explanation below, the set of features may refer to organisms involved in an anaerobic digestion process with the features being correlated based on abundance metrics or counts of the organisms at different times during the digestion process. In addition, the attributes may refer to classifications of the organisms as either acidogenic (denoted as “A”), methanogenic (denoted as “M”) and hydrolysis (denoted as “H”).

As shown in FIG. 4, the knowledge propagation system may obtain a partial correlation matrix 418 on which the graph 414 is based. As shown in the illustrated example, the partial correlation matrix 418 may include the values associated with the direct dependencies found in the graph 414 and zero values indicating non-dependencies in the graph 414.

As further shown in FIG. 4, the knowledge propagation system may generate an attribute matrix 426. In this example, the attribute matrix 426 represents an initial attribute matrix 426 in which attributes are known for each of the features except feature x₃. Thus, each of the features other than x₃ are assigned their known attribute values (e.g., 0 and 1 classifications associated with the classification of organisms) while x₃ is assigned a uniform distribution between A, M, and H.

As further shown in FIG. 4, the knowledge propagation system may generate a transition matrix 420. In accordance with examples discussed herein, the transition matrix 420 may be generated based on values of the partial correlation matrix 418 and a scaling intensity parameter, which may be selected to determine an intensity of the distribution of the values. As shown in FIG. 4, a sum of the distribution of the values for each row within the transition matrix 420 may be equal to one.

While not shown in FIG. 4, the knowledge propagation system may apply the transition matrix 420 to the attribute matrix 426 and cause attribute values within the attribute matrix 426 to shift towards a set of convergence values. In one or more embodiments, the known values may remain the same while the unknown values shift with each iteration (or in the case of the analytical approach, with performance of the analytical approaches function). In this example, because x₃ has a direct dependency to all the features other than x₆, each of features x₁, x₂, x₄, and x₅ will have a more significant impact on the shifting value of the attributes relative to x₆. In addition, it will be noted that x₂ will have a higher influence of the attribute value than other features. Moreover, it will be noted that both x₁ and x₄ will have an opposite impact on the attribute value due to negative correlations.

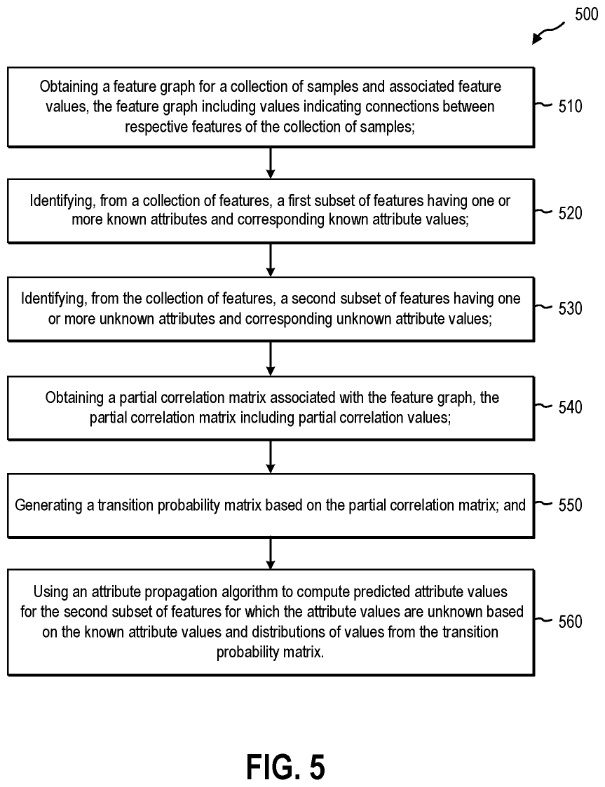

Turning now to FIG. 5, this figure illustrates an example flowchart including a series of acts 500 for propagating knowledge of attributes between nodes of a graph and generating a matrix of attribute values including a combination of known and predicted attributes for features of a collection of samples. While FIG. 5 illustrates acts according to one or more embodiments, alternative embodiments may omit, add to, reorder, and/or modify any of the acts shown in FIG. 5. The acts of FIG. 5 can be performed as part of a method. Alternatively, a non-transitory computer-readable medium can include instructions that, when executed by one or more processors, cause a computing device to perform the acts of FIG. 5. In still further embodiments, a system can perform the acts of FIG. 5.

As shown in FIG. 5, a series of acts 500 may include an act 510 of obtaining a feature graph for a collection of samples and associated feature values, the feature graph including values indicating dependencies between respective features of a collection of samples. Each sample of the collection of samples may be associated with one or more feature values. For example, the features may refer to values associated with the collection of samples on which the feature graph was trained. In one or more embodiments, the input data used to train the feature graph have been preprocessed such that the feature values have been normalized within a predetermined range of values. In one or more embodiments, the feature graph may be a conditional independence graph. In such graphs, feature Xᵢ is not directly dependent to feature Xⱼ if and only if features Xᵢ and Xⱼ are conditionally independent given all other features in the distribution learned based on the input dataset. The feature graph may be an undirected graph indicating direct dependencies determined from a graph recovery method.

The series of acts 500 may also include an act 520 of identifying from a collection of features, a first subset of features having one or more known attributes and corresponding known attribute values. In some embodiments, the first subset of features includes features having one or more partially known attributes corresponding to a known probability distribution over all possible attribute values for the corresponding attribute.

The series of acts 500 may also include an act 530 of identifying, from the collection of features, a second subset of features having one or more unknown attributes and corresponding unknown attribute values.

The series of acts 500 may also include an act 540 of obtaining a partial correlation matrix associated with the feature graph, the partial correlation matrix including partial correlation values.

The series of acts 500 may include an act 550 of generating a transition matrix or matrices based on the partial correlation matrix. The transition probability matrix may include distributions of weights associated with respective sample features based at least in part on the correlations between respective features indicated in the feature graph. The distributions of weights may further be based on a scaling intensity value selected for the transition matrix. The transition probability matrix may be generated by exponentiating each cell of the partial correlation matrix based on a scaling intensity parameter and row-normalizing such that each row of the correlation matrix represents a valid probability distribution. The transition probability matrix may be generated by generating a positive transition matrix based on only positive correlations and a negative transition matrix based on only negative correlations.

The series of acts 500 may also include an act 560 of using an attribute propagation algorithm to compute predicted attribute values for the second subset of features for which the attribute values are unknown based on the known attribute values and distributions of values from the transition probability matrix. For example, an attribute matrix may be generated or initialized with values representing the known attributes, unknown attributes and partially known attributes. The attribute matrix may represent or relate each feature with respect to the one or more known attributes, the one or more partially known attributes, and the one or more unknown attributes. For example, the one or more known attributes may be represented for each feature by the corresponding known attribute values (e.g., values of one in corresponding known attribute value columns and values of zero in other columns). The one or more partially known attributes may be represented for each feature by the known probability distributions for the corresponding partially known features. The one or more unknown attributes may be represented for each feature by a uniform distribution of initial attribute values.

In some embodiments, an iterative attribute propagation algorithm may be performed with respect to the attribute matrix. For example, the transition matrix may be applied to a current instance of the attribute matrix to generate a next instance of the attribute matrix with updated attribute values. Computing the predicted attribute values may include determining that a difference between the attribute values in matrix instances generated in consecutive iterations is small enough to determine that the process has converged to a set of converged attribute values. For example, the difference between two consecutive iterated instances may be less than or equal to a convergence threshold, which may indicate that the attribute values have converged. In some embodiments, a difference between the attribute values of two or more iterated instances of the attribute matrix may be determined not to have converged. For example, the difference between two consecutive iterated instances may be greater than the convergence threshold, indicating that the attribute values have not converged. As such, an additional next instance of the attribute matrix may be iteratively generated until the difference between the attribute values of two or more iterated instances of the attribute matrix has converged to the set of converged attribute values (e.g., the difference is less than or equal to the convergence threshold). Once converged, an output set of predicted attribute values may be generated based on the set of converged attribute values. As used herein, a convergence threshold may refer to a configurable threshold indicating a threshold difference between attribute values or distributions over attribute values of iterated instances (e.g., two or more consecutive iterations) that may be used in determining whether the two consecutive iterated instances have converged.

In some embodiments, generating the next instance of the attribute matrix with updated attribute values includes applying a regularization term to the updated attribute values. The regularization term may cause the process to converge faster or more slowly with each iteration.

The attribute propagation algorithm may use an analytical approach that determines a distribution over attribute values for the features with unknown attributes (and unknown attribute values). The transition matrix may be sorted into features based on known and unknown attributes such that the transition matrix may be split into a plurality of submatrices. The submatrices may include a first submatrix, a second submatrix, a third submatrix, and a fourth submatrix. The first submatrix may include features of unknown attribute in both rows and columns. The second submatrix may include features of known attributes in columns and features of unknown attributes in rows. The third submatrix may include features of unknown attributes in columns and features of known attributes in rows. The fourth submatrix may include features of known attribute in both rows and columns. The analytical model may include performing a functional combination of the plurality of submatrices with a known attribute matrix to generate the predicted attribute values. The known attribute matrix may be comprised of features having known attribute values.

FIG. 6 illustrates certain components that may be included within a computer system 600. One or more computer systems 600 may be used to implement the various devices, components, and systems described herein.

The computer system 600 includes a processor 601. The processor 601 may be a general-purpose single-or multi-chip microprocessor (e.g., an Advanced RISC (Reduced Instruction Set Computer) Machine (ARM)), a special-purpose microprocessor (e.g., a digital signal processor (DSP)), a microcontroller, a programmable gate array, etc. The processor 601 may be referred to as a central processing unit (CPU). Although just a single processor 601 is shown in the computer system 600 of FIG. 6, in an alternative configuration, a combination of processors (e.g., an ARM and DSP) could be used. In one or more embodiments, the computer system 600 further includes one or more graphics processing units (GPUs), which can provide processing services related to both entity classification and graph generation.

The computer system 600 also includes memory 603 in electronic communication with the processor 601. The memory 603 may be any electronic component capable of storing electronic information. For example, the memory 603 may be embodied as random-access memory (RAM), read-only memory (ROM), magnetic disk storage media, optical storage media, flash memory devices in RAM, on-board memory included with the processor, erasable programmable read-only memory (EPROM), electrically erasable programmable read-only memory (EEPROM) memory, registers, and so forth, including combinations thereof.

Instructions 605 and data 607 may be stored in the memory 603. The instructions 605 may be executable by the processor 601 to implement some or all of the functionality disclosed herein. Executing the instructions 605 may involve the use of the data 607 that is stored in the memory 603. Any of the various examples of modules and components described herein may be implemented, partially or wholly, as instructions 605 stored in memory 603 and executed by the processor 601. Any of the various examples of data described herein may be among the data 607 that is stored in memory 603 and used during execution of the instructions 605 by the processor 601.

A computer system 600 may also include one or more communication interfaces 609 for communicating with other electronic devices. The communication interface(s) 609 may be based on wired communication technology, wireless communication technology, or both. Some examples of communication interfaces 609 include a Universal Serial Bus (USB), an Ethernet adapter, a wireless adapter that operates in accordance with an Institute of Electrical and Electronics Engineers (IEEE) 802.11 wireless communication protocol, a Bluetooth® wireless communication adapter, and an infrared (IR) communication port.

A computer system 600 may also include one or more input devices 611 and one or more output devices 613. Some examples of input devices 611 include a keyboard, mouse, microphone, remote control device, button, joystick, trackball, touchpad, and lightpen. Some examples of output devices 613 include a speaker and a printer. One specific type of output device that is typically included in a computer system 600 is a display device 615. Display devices 615 used with embodiments disclosed herein may utilize any suitable image projection technology, such as liquid crystal display (LCD), light-emitting diode (LED), gas plasma, electroluminescence, or the like. A display controller 617 may also be provided, for converting data 607 stored in the memory 603 into text, graphics, and/or moving images (as appropriate) shown on the display device 615.

The various components of the computer system 600 may be coupled together by one or more buses, which may include a power bus, a control signal bus, a status signal bus, a data bus, etc. For the sake of clarity, the various buses are illustrated in FIG. 6 as a bus system 619.

The techniques described herein may be implemented in hardware, software, firmware, or any combination thereof, unless specifically described as being implemented in a specific manner. Any features described as modules, components, or the like may also be implemented together in an integrated logic device or separately as discrete but interoperable logic devices. If implemented in software, the techniques may be realized at least in part by a non-transitory processor-readable storage medium comprising instructions that, when executed by at least one processor, perform one or more of the methods described herein. The instructions may be organized into routines, programs, objects, components, data structures, etc., which may perform particular tasks and/or implement particular datatypes, and which may be combined or distributed as desired in various embodiments.

The steps and/or actions of the methods described herein may be interchanged with one another without departing from the scope of the claims. In other words, unless a specific order of steps or actions is required for proper operation of the method that is being described, the order and/or use of specific steps and/or actions may be modified without departing from the scope of the claims.

The term “determining” encompasses a wide variety of actions and, therefore, “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing and the like.

The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features. For example, any element or feature described in relation to an embodiment herein may be combinable with any element or feature of any other embodiment described herein, where compatible.

The present disclosure may be embodied in other specific forms without departing from its spirit or characteristics. The described embodiments are to be considered as illustrative and not restrictive. The scope of the disclosure is, therefore, indicated by the appended claims rather than by the foregoing description. Changes that come within the meaning and range of equivalency of the claims are to be embraced within their scope.

What is claimed is:

1. A method, comprising:
obtaining a feature graph for a collection of samples and associated feature values, the feature graph including values indicating dependencies between respective features of the collection of samples;
identifying, from a collection of features, a first subset of features having one or more known attributes and corresponding known attribute values;
identifying, from the collection of features, a second subset of features having one or more unknown attributes and corresponding unknown attribute values;
obtaining a partial correlation matrix associated with the feature graph, the partial correlation matrix including partial correlation values;
generating a transition probability matrix based on the partial correlation matrix; and
using an attribute propagation algorithm to compute predicted attribute values for the second subset of features for which the attribute values are unknown based on the known attribute values and distributions of values from the transition probability matrix.

2. The method of claim 1, wherein each sample of the collection of samples is associated with one or more features values.

3. The method of claim 1, wherein generating the transition probability matrix includes generating distributions of weights associated with respective features and based at least in part on the correlations between respective features indicated in the feature graph.

4. The method of claim 1, wherein the first subset of features includes features having one or more partially known attributes corresponding to a known probability distribution over all possible attribute values for the corresponding attribute.

5. The method of claim 4, further comprising initializing an attribute matrix that is comprised of each feature with respect to the one or more known attributes, the one or more partially known attributes, and the one or more unknown attributes for each feature, wherein the one or more known attributes are represented for each feature by the corresponding known attribute values, the one or more partially known attributes are represented for each feature by the known probability distributions for the corresponding partially known features, the one or more unknown attributes are represented for each feature by a uniform distribution of initial attribute values.

6. The method of claim 5, further comprising:
performing an iterative attribute propagation algorithm including applying the transition matrix to a current instance of the attribute matrix to generate a next instance of the attribute matrix with updated attribute values, and
determining that a difference between the attribute values of two consecutive iterated instances of the attribute matrix is less than or equal to a convergence threshold indicating that the attribute values have converged to a set of converged attribute values; and
generating an output set of the predicted attribute values based on the set of converged attribute values.

7. The method of claim 6, wherein performing the iterative attribute propagation algorithm further comprises:
determining that a difference between the attribute values of two consecutive iterated instances of the attribute matrix is greater than the convergence threshold, indicating that the attribute values have not converged; and
iteratively generating an additional next instance of the attribute matrix until the difference between the attribute values of two consecutive iterated instances of the attribute matrix is less than or equal to the convergence threshold indicating that the attribute values have converged to the set of converged attribute values.

8. The method of claim 7, wherein generating the next instance of the attribute matrix with updated attribute values includes applying a regularization term to the updated attribute values, the regularization term causing the iterative attribute propagation algorithm to converge faster or slower.

9. The method of claim 1, wherein the feature graph is one of:
a conditional independence graph; or
an undirected graph indicating direct dependencies determined from a graph recovery method.

10. The method of claim 1, wherein using the attribute propagation algorithm to compute the predicted attribute values includes using an analytical model that analytically determines a distribution of attributes over the features with unknown attributes, wherein using the analytical algorithm comprises:
sorting the transition matrix into features based on known and unknown attributes;
splitting the transition matrix into a plurality of submatrices, the plurality of submatrices including:
a first submatrix including features of unknown attributes in both columns and rows;
a second submatrix including features of known attributes in columns and features of unknown attributes in rows;
a third submatrix including features of unknown attributes in columns and features of known attributes in rows; and
a fourth submatrix including features of known attributes in both rows and columns; and
performing a functional combination of the plurality of submatrices with a known attribute matrix to generate the predicted attribute values, wherein the known attribute matrix is comprised of features having known attribute values.

11. The method of claim 1, wherein generating the transition probability matrix comprises exponentiating each cell of the partial correlation matrix based on a scaling intensity parameter and row-normalizing such that each row of the correlation matrix represents a valid probability distribution.

12. The method of claim 1, wherein generating the transition probability matrix comprises generating a positive transition matrix based on only positive correlations and generating a negative transition matrix based on only negative correlations.

13. A system, comprising:
at least one processor;
memory in electronic communication with the at least one processor; and
instructions stored in the memory, the instructions being executable by the at least one processor to:
obtain a feature graph for a collection of samples and associated feature values, the feature graph including values indicating dependencies between respective features of the collection of samples;
identify, from a collection of features, a first subset of features having one or more known attributes and corresponding known attribute values;
identify, from the collection of features, a second subset of features having one or more unknown attributes and corresponding unknown attribute values;
obtain a partial correlation matrix associated with the feature graph, the partial correlation matrix including partial correlation values;
generate a transition probability matrix based on the partial correlation matrix; and
use an attribute propagation algorithm to compute predicted attribute values for the second subset of features, for which the attribute values are unknown, based on the known attribute values and distributions of values from the transition probability matrix.

14. The system of claim 13, wherein the first subset of features includes features having one or more partially known attributes corresponding to a known probability distribution over all possible attribute values for the corresponding attribute.

15. The system of claim 14, wherein generating the transition probability matrix includes generating a transition matrix including distributions of weights associated with respective sample features and based at least in part on the correlations between respective features indicated in the feature graph.

16. The system of claim 14, further comprising initializing an attribute matrix that is comprised of each feature with respect to the one or more known attributes, the one or more partially known attributes, and the one or more unknown attributes for each feature, wherein the one or more known attributes are represented for each feature by the corresponding known attribute values, the one or more partially known attributes are represented for each feature by the known probability distributions for the corresponding partially known features, the one or more unknown attributes are represented for each feature by a uniform distribution of initial attribute values.

17. The system of claim 16, further comprising:
performing an iterative attribute propagation algorithm including applying the transition matrix to a current instance of the attribute matrix to generate a next instance of the attribute matrix with updated attribute values,:
determining that a difference between the attribute values of two consecutive iterated instances of the attribute matrix is less than or equal to a convergence threshold, indicating that the attribute values have converged to a set of converged attribute values; and
generating an output set of the predicted attribute values based on the set of converged attribute values.

18. The system of claim 17, wherein performing the iterative attribute propagation algorithm further comprises:
determining that the difference between the attribute values of two consecutive iterated instances of the attribute matrix is greater than the convergence threshold, indicating that the attribute values have not converged; and
iteratively generating an additional next instance of the attribute matrix until the difference between the attribute values of two consecutive iterated instances of the attribute matrix is less than or equal to the convergence threshold, indicating that the attribute values have converged to the set of converged attribute values.

19. The system of claim 18, wherein generating the next instance of the attribute matrix with updated attribute values includes applying a regularization term to the updated attribute values, the regularization term causing the iterative attribute propagation algorithm to converge faster or slower.

20. A non-transitory computer readable medium storing instructions thereon that, when executed by at least one processor, cause a computing device to:
obtain a feature graph for a collection of samples and associated feature values, the feature graph including values indicating dependencies between respective features of the collection of samples;
identify, from a collection of features, a first subset of features having one or more known attributes and corresponding known attribute values;
identify, from the collection of features, a second subset of features having one or more unknown attributes and corresponding unknown attribute values;
obtain a partial correlation matrix associated with the feature graph, the partial correlation matrix including partial correlation values;
generate a transition probability matrix based on the partial correlation matrix; and
use an attribute propagation algorithm to compute predicted attribute values for the second subset of features, for which the attribute values are unknown, based on the known attribute values and distributions of values from the transition probability matrix.
